(19) United States
(12) Patent Application Publication
(10) Pub. No.: US 2026/0099609 A1
(43) Pub. Date: Apr. 9, 2026

(54) VULNERABLE SOFTWARE EXPOSURE ASSESSMENT

(71) Applicant: ServiceNow, Inc., Santa Clara, CA (US)

(72) Inventors: Nitesh Tolani, Hyderabad (IN); Shivam Sarawagi, Hyderabad (IN); Venugopal Gottimukkula, Hyderabad (IN); Ravi Kumar Kanukollu, Hyderabad (IN)

(21) Appl. No.: 18/910,989

(22) Filed: Oct. 9, 2024

(51) Int. Cl. G06F 21/57

(52) U.S. Cl. CPC G06F 21/577; G06F 2221/033

(57) ABSTRACT

Aspects of the subject technology relate to systems, methods, and computer-readable media for identifying vulnerable software associated with an enterprise. A database of software assets associated with an enterprise can be maintained via a software asset management (SAM) system. A vulnerable software asset can be identified and a descriptor of the vulnerable software asset can be obtained. The descriptor can be mapped to a portion of the database of software assets. A likelihood that the vulnerable software asset is associated with the enterprise can be determined based on the mapping.

### BACKGROUND

### 1. Technical Field

The present disclosure generally relates to performing an assessment of an enterprise's exposure to a vulnerable software asset, and more specifically to determining a likelihood that the vulnerable software asset is associated with an enterprise.

### 2. Introduction

Exposure assessment is a key component of risk management and security enforcement within an enterprise. In order to assess exposure levels, software assets are analyzed to determine whether vulnerable software is present in an enterprise, and to quantify the vulnerability levels of the software for the enterprise. In turn, this can help in analyzing the impact of an attack through the vulnerable software and serve as a basis of mitigation strategies for the enterprise.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more aspects, components, devices, nodes, systems, instances, and/or portions of the example cloud computing architecture, according to some examples of the present disclosure;

FIG. 2 illustrates a schematic diagram of an environment for determining a likelihood that a vulnerable software asset is associated with an enterprise, according to some examples of the present disclosure;

FIG. 3 illustrates a flowchart of an example method of maintaining a vulnerable software model, according to some examples of the present disclosure;

FIG. 4 illustrates a flowchart of an example method of determining a likelihood that a vulnerable software asset is associated with an enterprise through a SAM system, according to some examples of the present disclosure;

FIG. 5 illustrates a flowchart of an example method of using machine learning to identify build versions associated with a vulnerable software asset and determining a likelihood that the vulnerable software asset is associated with an enterprise based on the build versions, according to some examples of the present disclosure;

FIG. 6 illustrates a flowchart of an example method of determining a likelihood that a vulnerable software asset is associated with an enterprise based on a package name associated with the vulnerable software asset, according to some examples of the present disclosure;

FIG. 7 illustrates an example screenshot of an interface showing descriptors of a vulnerable software asset, according to some examples of the present disclosure;

FIG. 8 illustrates an example screenshot of an interface showing a software model of an enterprise maintained by a SAM system, according to some examples of the present disclosure;

FIG. 9 illustrates an example screenshot of an interface showing descriptors of another vulnerable software asset, according to some examples of the present disclosure;

FIG. 10 illustrates an example screenshot of an interface representing a mapping of descriptors of a vulnerable software asset to a portion of a database of software assets associated with an enterprise, according to some examples of the present disclosure;

FIG. 11 illustrates an example screenshot of an interface representing a mapping of descriptors of a vulnerable software asset to a portion of a database of software assets associated with an enterprise, according to some examples of the present disclosure;

FIG. 12 illustrates an example screenshot of an interface representing another mapping of descriptors of a vulnerable software asset to a portion of a database of software assets associated with an enterprise, according to some examples of the present disclosure;

FIG. 13 illustrates an example screenshot of an interface showing an enterprise vulnerable software asset assessment and corresponding risk scores of vulnerable software assets, according to some examples of the present disclosure;

FIG. 14 illustrates an example screenshot of an interface showing a graphical representation of a vulnerability assessment, according to some examples of the present disclosure;

FIG. 15 is an example of a deep learning neural network that can be used to implement all or a portion of the systems and techniques described herein, according to some examples of the present disclosure;

FIG. 16 is a diagram illustrating an example architecture of an example transformer model, according to some examples of the present disclosure;

FIG. 17 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As discussed previously, exposure assessment is a key component of risk management and security enforcement within an enterprise. In providing exposure assessment, software assets are analyzed to determine whether vulnerable software is associated with an enterprise, and to quantify the vulnerability levels of the software for the enterprise. In turn, this can help in analyzing the impact of an attack through the vulnerable software and serve as a basis of mitigation strategies for the enterprise.

Descriptors of vulnerable software and a catalog of what software assets are associated with an enterprise can be analyzed to identify the presence of vulnerable software in an enterprise. Identifying what software assets are associated with an enterprise can be a difficult task, especially for enterprises that access a wide array of software assets. To determine what software assets are associated with an enterprise, agents can be implemented to scan run time flows at systems within the enterprise. The use of agents to identify the presence of vulnerable software assets in an enterprise is disadvantageous as it is time consuming and computationally expensive. Further, such agents are implemented through a third-party provider either at devices within an enterprise, or at a location for remote scanning of the devices within the enterprise. This is disadvantageous as it assumes a level of informational consistency exists between respective systems implemented by the third-party provider and the enterprise.

The disclosed technology addresses the foregoing by, in some implementations, using an agentless technique to identify software assets associated with an enterprise, and then determining vulnerable software asset exposure based on the catalog of software assets associated with the enterprise. Specifically, software assets associated with an enterprise can be inventoried in an agentless manner by abstaining from monitoring runtime software flows in the enterprise. For example, a software asset management (SAM) platform can be used to catalog software associated with an enterprise in an agentless manner. As follows the catalog of software assets can be used to determine vulnerable software asset exposure in the enterprise.

In analyzing descriptors of vulnerable software to determine whether the vulnerable software is associated with an enterprise, the descriptors can be mapped to software that is associated with the enterprise. Specifically, a string representing the vulnerable software asset in a string of a structured naming scheme can be mapped to strings representing software that is associated with the enterprise to determine whether the vulnerable software asset is in the enterprise. However, software may be represented differently across different strings of structured naming schemes. For example, variations and inconsistencies in the format and content can exist across Common Platform Enumeration (CPE) strings representing the same software asset. It is, therefore, difficult to map across strings of structured naming schemes to determine a likelihood of the presence of vulnerable software in an enterprise.

The disclosed technology addresses the foregoing by, in some implementations, applying approximate string matching to map descriptors of vulnerable software, as indicated by strings in a structured naming scheme, to software that is associated with an enterprise. Specifically, a CPE string associated with a vulnerable software asset can be mapped through approximate string matching to strings indicative of characteristics of software associated with an enterprise. As follows, a likelihood that the vulnerable software asset is associated with the enterprise can be determined based on a degree of matching between the strings. In matching strings, various descriptors of the vulnerable software asset can be extracted from strings associated with the vulnerable software asset. In turn, the descriptors that are extracted from the string can be processed to identify additional descriptors of the vulnerable software asset that can then be used to further match the vulnerable software asset to software assets associated with the enterprise. For example, a version and edition of a vulnerable software asset can be extracted from a CPE string. Then a machine learning model can be applied to the portions of the string that are indicative of the version and edition to identify the different build versions of the vulnerable software asset. The build versions of the vulnerable software asset can then be used to map the vulnerable software asset to software assets associated with the enterprise.

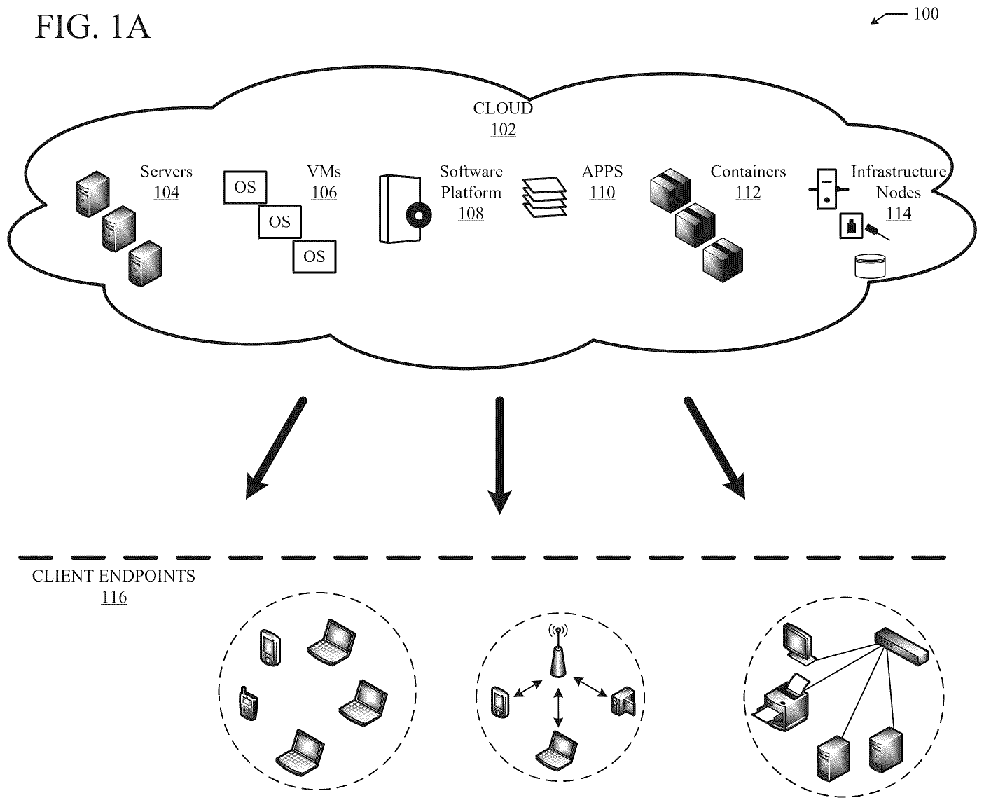

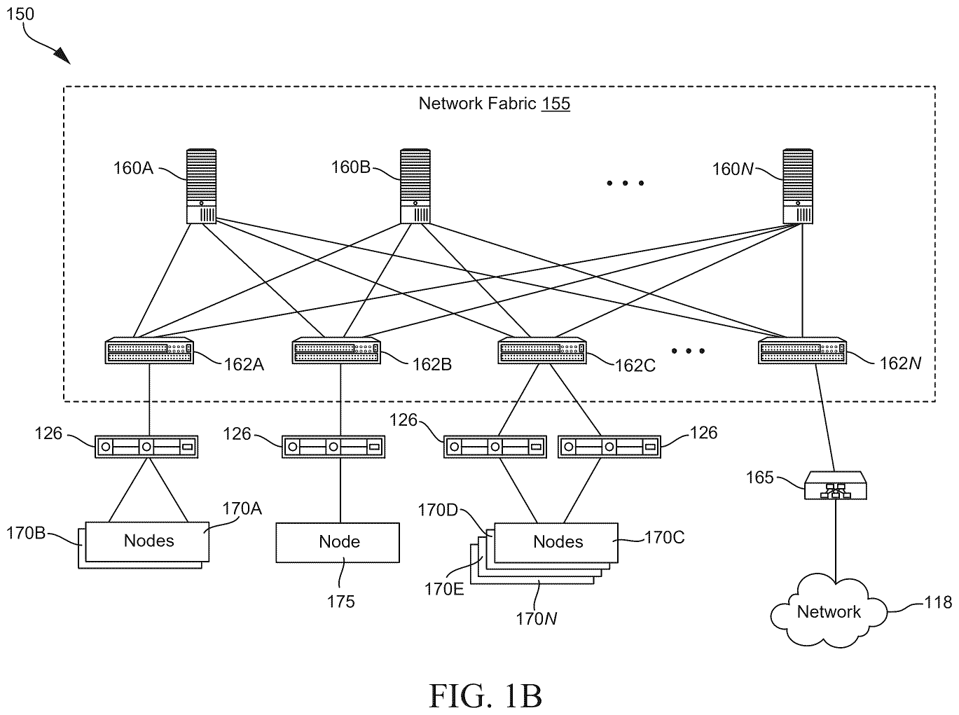

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more aspects, components, devices, nodes, systems, instances, and/or portions of the example multimedia environment 102 (and/or copies/instances thereof) shown in FIG. 1A can be implemented by and/or in a cloud network or datacenter. For example, any portion (or all) of the network 118, any of the content servers 120 (or all), and/or any of the system servers 126 (or all) can be implemented by and/or in a cloud network or datacenter. In other cases, one or more aspects, components, devices, nodes, systems, instances, and/or portions of the example multimedia environment 102 (and/or copies/instances thereof) shown in FIG. 1A can additionally or alternatively be implemented by and/or in any other network or datacenter, such as an on-premises datacenter, any type of campus network, any type of enterprise network, and/or any other type of network and/or datacenter. An example network architecture that can be used to implement any such network or datacenter (or any portion thereof), such as a cloud network/datacenter or an on-premises network/datacenter, is shown in FIG. 1B and further described below.

FIG. 1B is a block diagram illustrating an example network architecture 150 that can be used to implement one or more aspects, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

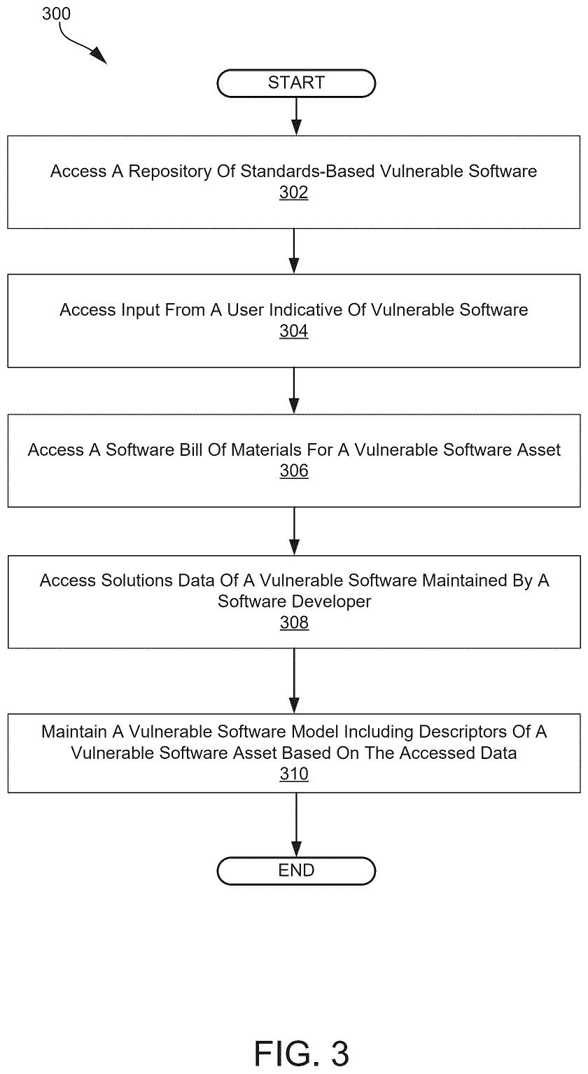

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some aspects, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

An enterprise network can be implemented through the cloud computing architecture 100 shown in FIG. 1A and the network architecture 150 shown in FIG. 1B. Further, asset management (e.g., SAM) can be performed for an enterprise through the cloud computing architecture 100 shown in FIG. 1A and the network architecture 150 shown in FIG. 1B. In particular, SAM system can be embodied in management server(s) associated with a provider instance, which is in communication with multiple user or client instances. Each client instance can be propagated to one or multiple client devices, from which respective users can utilize multiple software programs through the respective client instance. Notably, each client instance can generally be aware of or able to access an identifier or identifier number, such as a stock keeping unit (SKU) or publisher part number (PPN), of each software program of the client instance. To enable asset management of the software programs used across multiple client instances, the management server can maintain one or multiple databases that enable association of the identifiers or descriptors with respective software models. Each software model generally defines a specific set of attributes/descriptors (e.g., name, publisher, edition, version) of the underlying software program. Thus, based on the one or more databases, the management server of the management system converts or translates the descriptors into digestible or recognizable software models that are leveraged for software analysis, metering, and/or management.

As used herein, the term “software model” refers to a data structure that defines or identifies a particular software program to enable software asset management for the particular software program. A software model may be individually configured for each respective variation of a software program. Further, each software model may be defined by a set of attributes, otherwise descriptors, that distinguish the software program from other software programs and the software program from other variations of the software program, including a software program product name, a software program license type, a software program edition, a software program version, a software program release, a software program patch, a software publisher name, and so forth. As used herein, the term “version” refers to a respective build or build file associated with a given software program or software application installable on client devices of an enterprise network. The version of a software program may be denoted by a numeric representation that corresponds to changes or developments made to a software application, such as 1.0, 2.0, 2.05, 8.50.3, and so forth. As used herein, the term “edition” refers to the bundling, packaging, or selling of a respective software program within a software package for different experiences or degrees of completeness. As such, it is to be understood that a respective version of a software program may be available in multiple editions that each are targeted to a different segment of end-users, and that the version of a software program is distinct from or independent of an edition of the particular software program. Some examples of editions include standard, professional, home, education, enterprise, and so forth. Moreover, respective software licenses that accompany various software programs may differ in pricing for different editions, such that higher-end or more complete editions of a respective software program are more expensive than lower-end or less complete editions of the same software program. Thus, as used herein, the term “software asset management” or “SAM” refers to the analysis and/or monitoring of the software programs utilized by clients with respect to generating suitable recommendations regarding software license management, software cost analysis, software usage analysis, and so forth of the software programs of various editions and/or versions. SAM can be performed across an enterprise for various clients.

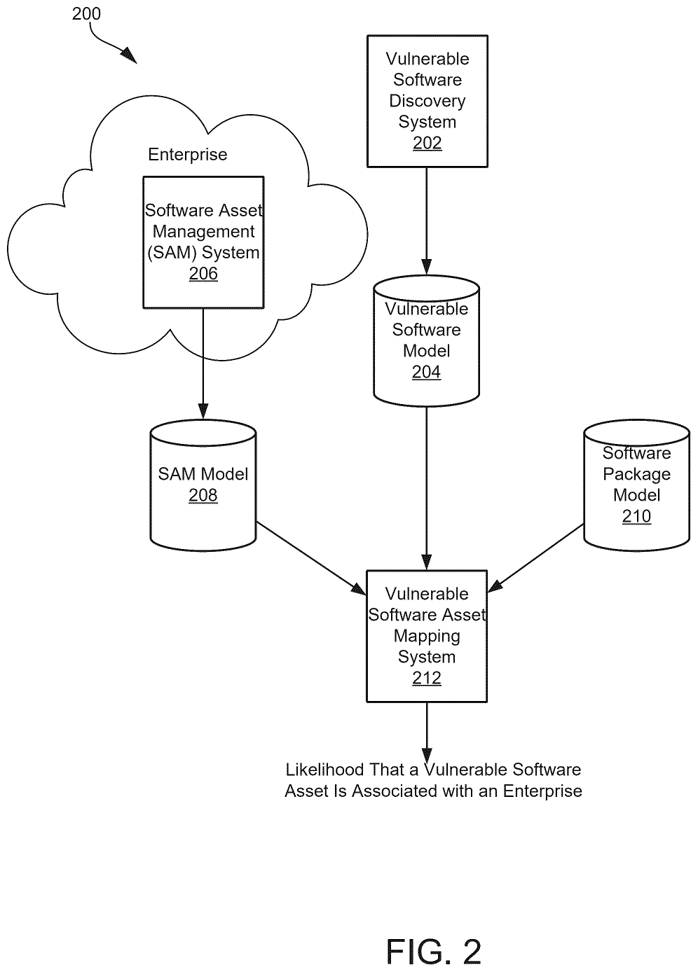

FIG. 2 illustrates a schematic diagram of an environment 200 for determining a likelihood that a vulnerable software asset is associated with an enterprise, according to some examples of the present disclosure. Specifically, the environment 200 shown in FIG. 2 can be used to detect whether a vulnerable software asset is associated with an enterprise in an agentless manner, e.g. through a SAM system. Detecting whether a vulnerable software asset is associated with an enterprise in an agentless manner, as used herein, can include detecting a likelihood that a vulnerable software asset is associated with an enterprise, without deploying agents into an enterprise network, e.g. on devices within the network. Further, an agentless manner, as used herein, can include detecting a likelihood that a vulnerable software asset is associated with an enterprise, while abstaining from monitoring runtime software flows in the enterprise.

Whether a vulnerable software asset is associated with an enterprise can include whether the vulnerable software asset is present or otherwise accessible through a device in an enterprise network. For example, a vulnerable software asset can be associated with an enterprise network if the enterprise has a license to the software asset. In another example, a vulnerable software asset can be associated with an enterprise network if the asset has been deployed to devices within the network.

The example environment shown in FIG. 2 includes a vulnerable software discovery system 202, a vulnerable software model datastore 204, a SAM system 206, a SAM model datastore, a software package model datastore 210, and a vulnerable software asset mapping system 212. The vulnerable software discovery system 202 functions to maintain vulnerable software models stored in the vulnerable software model datastore 204. A vulnerable software model, as used herein, can included descriptors of a vulnerable software asset. A descriptor of a software asset can include applicable information that characterizes a software asset such that the descriptor can be used to identify the software asset, at least in part. For example, descriptors of a software asset can include an identification of a publisher of the software asset, an identification of the product name of the software asset, a version of the software asset, an edition of the software asset, a build version of the software asset, a software package associated with the software asset, and other applicable information that characteri the software asset.

In maintaining vulnerable software models, the vulnerable software discovery system 202 can identify that a specific software asset is a vulnerable software asset. A vulnerable software asset, as used herein, can include software programs that have security flaws or weaknesses that could be exploited by a threat source to compromise the security and functionality of a system. For example, a vulnerable software asset can be a software program that allows an attacker to implement a denial-of-service attack or inject malware into a system. The vulnerable software discovery system 202 can identify that a software asset is vulnerable from an applicable source for identifying a vulnerable software asset. For example, the vulnerable software discovery system 202 can identify a vulnerable software asset from a database of standards-based vulnerability management data, solutions data published by a software developer, vulnerability data manually input by a user, a software bill of materials (SBOM) associated with the software asset, or a combination thereof.

Further in maintaining vulnerable software models, the vulnerable software discovery system 202 can gather data indicative of the descriptors of vulnerable software assets. Additionally, the vulnerable software discovery system 202 can extract the descriptors of the vulnerable software assets from the gathered data. As follows, the vulnerable software discovery system 202 can add the descriptors and/or the gathered data to the software asset models as part of creating the software asset models and updating the software asset models. For example, the vulnerable software discovery system 202 can gather an SBOM associated with a vulnerable software asset. Further in the example, the vulnerable software discovery system 202 can extract descriptors of the vulnerable software asset from the SBOM. For example, the vulnerable software discovery system 202 can identify a software package that includes a vulnerable software asset from an SBOM associated with the vulnerable software asset.

Data indicative of the descriptors of vulnerable software assets can be part of a structured naming scheme. In turn, the vulnerable software discovery system 202 can extract descriptors of vulnerable software assets from the structured naming scheme. A structured naming scheme, as used herein, can be a naming convention for a software program that is agreed upon, stipulated, or generally accepted as a standard. For example, a structured naming scheme can include a CPE string naming structure for software assets and the vulnerable software discovery system 202 can extract descriptors of the software assets from corresponding CPE strings. In another example, a structured naming scheme can include a Common Vulnerabilities and Exposures (CVE) naming structure and the vulnerable software discovery system 202 can extract descriptors of the software assets from the CVE entry. Data in the structured naming scheme of a software asset, and extracted descriptors for the software asset, can be included as part of a software model for the software asset.

Descriptors of the vulnerable software asset can be extracted by the vulnerable software system 202 in a string format. Specifically, the vulnerable software system 202 can extract descriptors of vulnerable software assets as sequences of characters that form the descriptor. For example, the vulnerable software system 202 can extract, e.g. from a CPE string or a CVE entry, an identification of a publisher of a vulnerable software asset, a name the vulnerable software asset, a version of the vulnerable software asset, and an edition of the vulnerable software asset as distinct strings. In another example, the vulnerable software system 202 can extract from an SBOM, a name of a vulnerable software asset and an identification of a software package that includes the vulnerable software asset as distinct strings.

The SAM system 206 functions to perform SAM for the enterprise. Specifically, the SAM system 206 can monitor what software assets are associated with the enterprise. More specifically, the SAM system 206 can track and manage software licenses within the enterprise and what corresponding software is used by entities within the enterprise. The SAM system 206 can perform these functions across the enterprise so that the software assets that are associated with the enterprise can be identified and managed across the enterprise through a single system.

In performing SAM functions, the SAM system 206 can maintain software models of software assets that are associated with the enterprise. Such software models can be maintained in the SAM model datastore 208. The software models, as discussed previously, can include descriptors of a software asset. Specifically, the software models can be defined by a set of attributes or descriptors that distinguish software assets from each other and a specific software asset across different variations or versions of the specific software asset. For example, the SAM models stored in the SAM model datastore 208 can include a software asset name, a software asset license type, a software asset edition, a software asset version, a software asset release, a software asset patch, a software publisher name, and so forth.

The SAM system 206 and SAM model datastore 208 can be implemented through the cloud computing architecture 100 shown in FIG. 1A and the network architecture 150 shown in FIG. 1B. Further, the SAM system 206 and the SAM model datastore 208 can be implemented in an agentless manner. Specifically, the SAM system 206 can monitor what software assets are associated with the enterprise without deploying agents in the enterprise network. Further, the SAM system 206 can monitor what software assets are associated with the enterprise while abstaining from monitoring runtime software flows in the enterprise.

The software package model datastore 210 stores data of software assets that are related to software packages associated with an enterprise. Specifically, the software package model datastore 210 stores models of software assets associated with an enterprise, otherwise enterprise software package models. Such models can be identified through data describing software packages that are accessible to or present in the enterprise. For example, an enterprise can input an SBOM of a software asset for which the enterprise has obtained a license. As follows, descriptors of the software asset can be identified from the SBOM and included in a software package model for the software asset that is stored in the software package model datastore 210. The software package models stored in the software package model datastore 210 can be maintained in an agentless manner by an applicable system. For example, the software package models stored in the software package model datastore 210 can be maintained for the enterprise by the SAM system 206.

The vulnerable software asset mapping system 212 functions to determine a likelihood that a vulnerable software asset is associated with the enterprise. Specifically, the vulnerable software asset mapping system 212 can map a vulnerable software model stored in the vulnerable software model datastore 204 to the enterprise software models stored in the SAM model datastore 208. In turn, the vulnerable software asset mapping system 212 can determine a likelihood that the vulnerable software asset is associated with the enterprise based on a degree of matching between the software model of the vulnerable software asset and an enterprise software model. A degree of matching between software models, as used herein, can comprise an applicable qualification or quantification of an amount of matching between software models. For example, if 70% of software models match, e.g. either directly or within a specific amount, then the degree of matching between software models can be qualified as having a high degree of matching or quantified as matching by 70%.

Further, the vulnerable software asset mapping system 212 can compare vulnerable software models to software package models to determine a likelihood that a vulnerable software asset is associated with the enterprise. Specifically, the vulnerable software asset mapping system 212 can compare the vulnerable software models stored in the vulnerable software model datastore 204 to the software package models associated with the enterprise and stored in the software package model datastore 210. In turn, the vulnerable software asset mapping system 212 can determine a likelihood that the vulnerable software asset is associated with the enterprise based on a degree of matching between a software model of a vulnerable software asset and an enterprise software package model. As discussed previously, as degree of matching between software models, including a vulnerable software model and a software package model can comprise an applicable qualification or quantification of an amount of matching between software models.

In various embodiments, the vulnerable software asset mapping system 212 can map descriptors of software assets in corresponding software models as part of comparing the software models with each other. Specifically, the vulnerable software asset mapping system 212 can map descriptors of vulnerable software assets, as included in vulnerable software models, to descriptors of software assets included in the software models and the software package models that are associated with the enterprise and stored in the SAM model datastore 208 and the software package model datastore 210. The vulnerable software asset mapping system 212 can use string matching, e.g. approximate string matching, to map descriptors of software assets across models. Specifically, the vulnerable asset mapping system 212 can map an identification of a publisher of a software asset, an identification of a product name of the software asset, an identification of a version of the software asset, an identification of an edition of the software asset, an identification of a software package of the software asset, the entire string representing the software asset, otherwise a display name, a build version of the software asset, or a combination thereof across different software models using string matching. For example, the vulnerable software asset mapping system 212 can use string matching to map the product name of a vulnerable software asset in a CPE string to a product name of an enterprise software asset, as represented in a software model.

The vulnerable software asset mapping system 212 can determine a likelihood that a vulnerable software asset is associated with an enterprise based on a degree of to which descriptors of software assets match across the software models. Specifically, the vulnerable software asset mapping system 212 can determine a likelihood that a vulnerable software asset is associated with an enterprise based on a degree to which the strings of the descriptor(s) of the vulnerable software assets match with the strings of the descriptor(s) of an enterprise software asset. Such matching can be defined with respect to thresholds. For example, if a string representing a publisher of a vulnerable software asset matches a string representing a publisher of an enterprise software asset within a certain threshold, then the vulnerable software asset can match the enterprise software asset to a certain degree. Further, such matching can be defined with respect to whether an exact match exists. For example, a vulnerable software asset and an enterprise software asset can match exactly if their display names in a string of a structured naming scheme match exactly.

FIG. 3 illustrates a flowchart 300 of an example method of maintaining a vulnerable software model, according to some examples of the present disclosure. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in any order and can include fewer or more modules than illustrated. Each module shown in FIG. 3 represents one or more steps, processes, methods or routines in the method. The modules will be discussed with respect to the example environments described herein.

At module 302, a repository of standard-based vulnerable software data is accessed. A repository of standards-based vulnerable software data can include an applicable repository of data of using specific standards to perform vulnerability management, measurement, and policy compliance for an enterprise. For example, the repository of standards-based vulnerable software data can include data for implementing the Security Content Automation Protocol (SCAP) in performing vulnerability management, measurement, and policy compliance. The repository can be maintained by a centralized or controlling entity. For example, the repository can comprise the National Vulnerability Database (NVD) that is maintained by the U.S. government. The repository of standards-based vulnerable software data can be accessed by the vulnerable software discovery system 202 to identify vulnerable software assets and descriptors of the vulnerable software assets.

At module 304, input from a user that is indicative of vulnerable software is accessed. The input from the user can indicate a specific software asset that is vulnerable. Further, the input from the user can indicate a specific software package that contains vulnerable software. The input can also include descriptors of vulnerable software assets. For example, the input can include identification of a publisher of a software asset, an identification of a product name of the software asset, an identification of a version of the software asset, an identification of an edition of the software asset, an identification of a software package of the software asset, a display name of the software asset in a structured naming scheme, or a combination thereof. The vulnerable software discovery system 202 can utilize the user input to identify vulnerable software assets and descriptors of the vulnerable software assets.

At module 306, an SBOM associated with a vulnerable software asset is accessed. An SBOM can comprise an inventory of components that are used to build a software asset. The SBOM associated with the vulnerable software asset can be accessed as part of a plurality of different SBOMs, which are not all necessarily associated with a vulnerable software asset. For example, the SBOM can be accessed from a plurality of different SBOMs for different software assets that are accessed by an enterprise. The SBOM can be made available from an applicable source. For example, an enterprise can provide the SBOMs of the software assets associated with the enterprise. In another example, the SBOM can be obtained from a publicly accessible source. The SBOM can be accessed by the vulnerable software discovery system 202 to identify packages that contain a vulnerable software asset and descriptors of the packages that contain the vulnerable software asset. For example, the vulnerable software discovery system 202 can identify a vulnerable software asset and query the SBOM to see if the vulnerable software asset was used in building the software package that is the subject of the SBOM. As follows, if the vulnerable software asset was used in building the software package, then the vulnerable software discovery system 202 can associate the software package with a vulnerable software asset.

At module 308, solutions data of a vulnerable software asset is accessed. The solutions data can be maintained by a software developer of the vulnerable software asset. The solutions data can be accessed as part of periodic or real-time monitoring of software developers publishing advisories of vulnerable software. For example Red Hat® can publish an advisory that a software asset it has developed is vulnerable. As follows, the vulnerable software discovery system 202 can then determine that the software asset is vulnerable based on the published advisory. Further, the vulnerable software discovery system 202 can identify descriptors of the vulnerable software asset from the advisory.

Real-time, as used herein, can be defined as near instantaneous (e.g., consider sampling rates, etc.) and can include latency in communication (e.g., telemetry, etc.). For example, real-time can be instantaneous if communication between a controller and models are of zero latency. However, if the communication between a controller and models has as latency of 1 minute then real-time can be instantaneous plus 1 minute. In general, real-time means instantaneous plus latency or other system delay time. Other system delay time can include transmission time delay, acquisition time delay, processing time delay, or other system delays.

The data that is accessed at modules 302 through 308 can be in the form of a CPE entry, a CVE entry, or an applicable entry associated with an SBOM. The content of such entries can vary across the sources. For example, different sources may use different names or abbreviations for the same product or vendor.

Further, the data that is accessed at modules 302 through 308 can be accessed continuously at periodic intervals, in real-time, or in near real-time. Continuously monitoring vulnerable software data sources to identify vulnerable software is technically advantageous in that vulnerable software assets can be discovered quickly and efficiently. In turn, a threat assessment can be performed for an enterprise shortly after discovery of a vulnerable software asset, which can ultimately limit the enterprise's exposure to the discovered vulnerable software. Further, monitoring multiple data sources to determine vulnerable software is technically advantageous in that it creates both redundancy and diversity in the sources used for discovery.

At module 310, a vulnerable software model, including descriptors of a vulnerable software asset, is maintained for the vulnerable software asset based on the accessed data. Specifically, the vulnerable software discovery system 202 can maintain the vulnerable software model based on the accessed data. In maintaining a vulnerable software model, descriptors of a discovered vulnerable software asset can be added to a model. Such descriptors can be extracted as string and added to the model as the strings, e.g. from a structured naming scheme. For example, descriptors of a vulnerable software asset can be added to a model for the asset as strings that are extracted from a CPE entry, a CVE entry, an SBOM, or a combination thereof. Further in the example, the CPE entry and CVE entry can be added to the model for the asset as a display name for the asset. In turn, such vulnerable software models can be used to perform enterprise exposure assessments to vulnerable software assets.

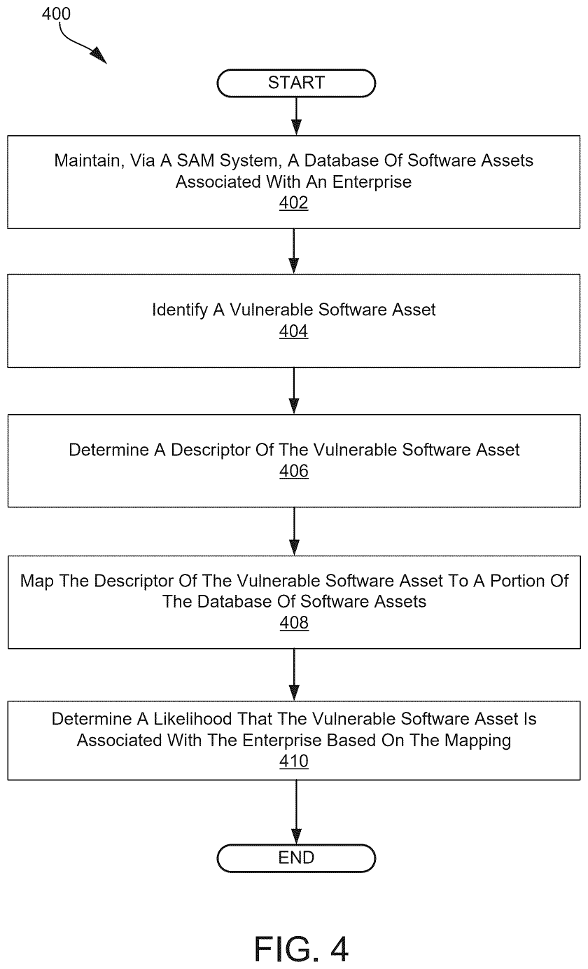

FIG. 4 illustrates a flowchart 400 of an example method of determining a likelihood that a vulnerable software asset is associated with an enterprise through a SAM system, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example environments described herein.

At module 402, a database of software assets associated with an enterprise is maintained through a SAM system, e.g. the SAM system 206. Specifically, the SAM system 206 can perform the functionalities described herein in relation to software asset management to maintain software models of software assets that are associated with the enterprise. Such software models can include descriptors of the software assets associated with the enterprise can include strings that characteristics the software assets. Such software models can be stored in the database of software assets that are associated with the enterprise. Therefore, the database of software assets can include software models with descriptors of software assets that are associated with the enterprise.

At module 404, a vulnerable software asset is identified. The vulnerable software asset can be identified by the vulnerable software discovery system 202. Specifically, the vulnerable software asset can be identified by accessing a repository of standard-based vulnerable software data, input from a user that is indicative of vulnerable software, an SBOM associated with a vulnerable software asset, solutions data of a vulnerable software asset, or a combination thereof. For example, the vulnerable software discovery system 202 can identify that a software asset is vulnerable by accessing a published report in the NVD. In another example, the vulnerable software discovery system 202 can identify that a software asset is vulnerable based on a solution published by a software developer.

At module 406, a descriptor of the vulnerable software asset is determined. The vulnerable software discovery system 202 can determine the descriptor of the vulnerable software asset in response to determining that the software asset is indeed vulnerable. The descriptor can be extracted from data that is accessed from a repository of standard-based vulnerable software data, input from a user that is indicative of vulnerable software, an SBOM associated with a vulnerable software asset, solutions data of a vulnerable software asset, or a combination thereof. The extracted descriptor can be added to a vulnerable software model for the vulnerable software asset.

The descriptor can be extracted from a string in a structured naming scheme, e.g. a CPE entry, a CVE entry, or an SBOM. Specifically, the vulnerable software discovery system 202 can use string searching to extract a descriptor from a CPE entry, a CVE entry, and an SBOM. For example, the vulnerable software discovery system 202 can extract an identification of a publisher of a vulnerable software asset, an identification of a product name of the vulnerable software asset, an identification of a version of the vulnerable software asset, and an edition of the vulnerable software asset.

At module 408, the descriptor of the vulnerable software asset is mapped to a portion of the database of software assets. Specifically, the vulnerable software asset mapping system 212 can map the descriptor of the vulnerable software asset to a corresponding descriptor of a software asset that is associated with the enterprise. This can be done by mapping vulnerable software models to SAM models of software assets associated with the enterprise that are maintained by the SAM system 206. The mapping can be performed through approximate string matching. Specifically, the mapping can be performed through approximate string matching within a specific threshold. For example, the descriptor can be mapped to a descriptor of a software asset associated with the enterprise if the descriptors match each other within a specific degree.

As discussed previously the content in descriptors of software assets can vary across sources. Specifically, even if strings representing a software asset are in the same structured format, e.g. a CPE string, the actual content of the descriptors within the string can vary across sources. For example, different sources use different names or abbreviations for the same product or vendor. In another example, different sources can omit details from descriptors of a software asset in a structured naming scheme. As a result, variations exist across specific descriptors and strings that represent software assets. In particular, variations exist between descriptors of vulnerable software assets, e.g. as included in vulnerable software models, and descriptors of software assets associated with an enterprise and included in software models maintained by the SAM system 206 for the enterprise. Mapping descriptors to each other, at module 408, through approximate string matching provides a technical advantage by accounting for such variations between descriptors. In particular, matching a descriptor of a vulnerable software asset to a portion of the database of software assets that matches within a specific degree provides a technical advantage by accounting for such variations between descriptors.

At module 410, a likelihood that the vulnerable software asset is associated with the enterprise, otherwise referred to as a threat level for the enterprise, is determined based on the mapping. Specifically, the vulnerable software asset mapping system 212 can determine a likelihood that the vulnerable software asset is associated with the enterprise based on the mapping. The vulnerable software asset mapping system 212 can determine a threat level for the enterprise based on a mapping of an identification of a publisher of vulnerable software, an identification of a product name of the vulnerable software, a version of the vulnerable software, an edition of the vulnerable software, a display name of the vulnerable software in a structured naming scheme, a build version of the vulnerable software, or a combination thereof.

The threat level of the vulnerable software asset can be quantified or qualified in an applicable way. In particular, the vulnerable software asset mapping system 212 can assign a numerical confidence score indicating a likelihood that the vulnerable software asset is associated with the enterprise. The confidence score can be calculated by weighting the matching of different descriptors and weighting the degree to which different descriptors match.

TABLE 1

| Vulnerable | Discovery | | Discovery Model | Exact |
|---|---|---|---|---|
| Software | model | | Exact Match | Match |
| segment | segement | Score | Segement | Score |
| Publisher | Display Name | 15 | Publisher | 5 |
| Model | Display Name | 15 | Model | 5 |
| Version | Display Name | 10 | Version | 5 |
| Edition | Display Name | 3 | Normalized Edition | 2 |
| Display Name | Display Name | 10 | Display Name | 5 |
| | | | Sum of all scores | 75 |
| | | | Base score | 25 |
| | | | Total score | 100 |

Table 1 shows an example scoring scheme for generating a confidence score that represents a likelihood that the vulnerable software asset is associated with the enterprise. As shown in table 1, the descriptors are weighted differently. Specifically, 15 points is given if the publisher and model descriptors match to a degree, 10 points is given if the version matches to a degree, 3 points is given if the edition matches to a degree, and 10 points is given if the display name in the structured naming scheme matches to a degree. Further, additional points can be awarded if there is an exact match between descriptors. Specifically, 5 points is given for each exact match of the publisher, the model, the version, and the display name and 2 points is given if the normalized edition exactly matches. This totals 75 possible points. This score can then be added to the base score of 25 to obtain a total score out of 100. The scoring scheme represented in Table 1 is merely an example, and in various embodiments, different criteria and weights can be used in generating a confidence score that a vulnerable software asset is associated with the enterprise.

As discussed previously, the database of software assets can be maintained at module 402 in an agentless manner. Specifically, the database of software assets can be maintained without installing an agent on systems or devices of the enterprise. Further in maintaining the database of software assets in an agentless manner, the database of software assets can be maintained without monitoring runtime flows at systems and devices in the enterprise. As a result, the descriptor of the vulnerable software asset can be mapped, at module 408, to software assets associated with the enterprise in an agentless manner. As follows, a threat assessment for the vulnerable software asset in the enterprise can be performed, at module 410, in an agentless manner. Performing these modules in an agentless manner offers numerous technical advantages. Specifically, this can reduce the time and the amount of computational resources used in ultimately performing a threat assessment for the enterprise. Further, this can obviate a need for any informational consistency between the enterprise and a third-party who provides the threat assessment.

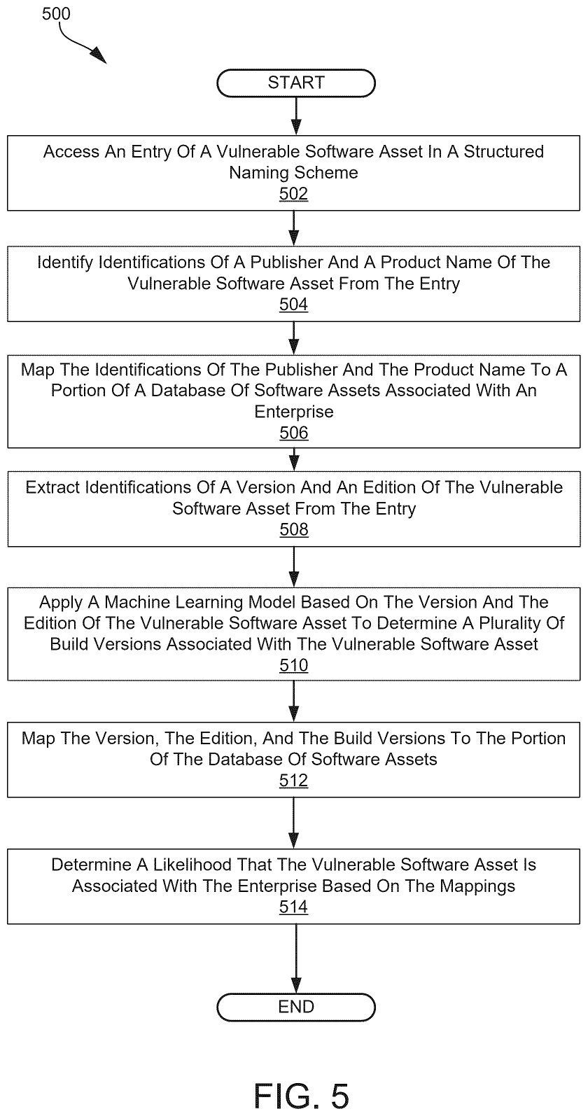

FIG. 5 illustrates a flowchart 500 of an example method of using machine learning to identify build versions associated with a vulnerable software asset and determining a likelihood that the vulnerable software asset is associated with an enterprise based on the build versions, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example environments described herein.

At module 502, an entry of a vulnerable software asset is accessed in a structured naming scheme. Specifically, the vulnerable software discovery system 202 can access an entry of a vulnerable software asset in a structured naming scheme. For example, a CPE string for a vulnerable software asset can be accessed.

At module 504, identifications of a publisher and product name of the vulnerable software asset is identified from the entry. Specifically, the vulnerable software discovery system 202 can extract an identification of a publisher and an identification of a product name of the vulnerable software asset. Such information can be extracted based on a known position of the publisher and the product name in the structured naming scheme. For example, the publisher and the product name are at defined positions in a CPE string. As a result, an identification of the publisher and the product name can be extracted from the CPE string based on these defined positions.

At module 506, the identifications of the publisher and the product name are mapped to a portion of a database of software assets associated with an enterprise. Specifically, the vulnerable software asset mapping system 212 can map identifications of the publisher and the product name to software models of software assets associated with an enterprise. Such software models can be maintained by the SAM system 206 in an agentless manner. The mapping can be performed through approximate string matching to match the identifications of the publisher and the product name to identifications of publishers and product names of software assets associated with the enterprise.

At module 508, identifications of a version and an edition of the vulnerable software asset are extracted from the entry. Specifically, the vulnerable software discovery system 202 can extract an identification of a version and an identification of an edition of the vulnerable software asset. Such information can be extracted based on a known position of the version and the edition in the structured naming scheme. For example, the version and the edition are at defined positions in a CPE string. As a result, an identification of the version and the edition can be extracted from the CPE string based on these defined positions.

At module 510, a machine learning model is applied based on the version and the edition of the vulnerable software asset to determine a plurality of build versions associated with the vulnerable software asset. Specifically, the vulnerable software discovery system 202 can implement or incorporate a machine learning model and apply the model based on the version and edition of the vulnerable software asset to determine different build versions for the asset. An applicable machine learning model can be applied to identify the different build versions for the vulnerable software asset. For example, a large language model (LLM) can be applied to identify the different build versions for the vulnerable software asset.

At module 512, the version, the edition, and the build versions are mapped to the portion of the database of software assets. Specifically, the vulnerable software asset mapping system 212 can map the version, the edition, and the build versions identified at module 510 to the portion of the database of software assets. The version, the edition, and the build versions can be mapped based on a degree to which the descriptors match descriptors of software assets associated with the enterprise. Further, the version, the edition, and the build versions can be mapped based on whether the descriptors exactly match descriptors of software assets associated with the enterprise. The version and edition can be mapped together with each of the build versions such that an instance is created for each of the build versions that includes the version and the edition. Therefore, each of the build versions can be mapped separately.

For a specific version of a software asset there can be a vast number of different build versions for the software asset. As a result, it can be difficult to identify all of the different build versions of a vulnerable software asset. This makes it difficult to use build version of a software asset as a descriptor for matching the vulnerable software asset to a software asset that is associated with an enterprise. However, SAM systems can maintain software models for software assets associated with an enterprise based on build versions of the software assets. Accordingly, build version can be a reliable descriptor for performing a threat assessment in software systems maintained by SAM systems. Therefore, using a machine learning language model to identify the different build versions of a vulnerable software asset is technically advantageous in that it can facilitate the matching of vulnerable software assets to assets associated with an enterprise based on build version. In turn, this is technically advantageous as using a build version to match software assets can provide a more accurate matching between the assets, in particular when dealing with software models that are maintained by a SAM system.

At module 514, a likelihood that the vulnerable software asset is associated with the enterprise is determined based on the mappings. Specifically, the vulnerable software asset mapping system 212 can perform a threat assessment based on both the mapping of the identifications of the publisher and product name to the portion of the database of software assets associated with the enterprise and the mapping of each of the build versions, along with the version and the edition, to the portion of the database of software assets associated with the enterprise. The threat assessment can be performed for each of the identified build versions. For example, a confidence score can be generated for each of the build versions, along with the version and edition for the software asset. In turn, the confidence score can be compared to a confidence score generated based on the mapping of the identifications of the publisher and product to see if the generated build version potentially matches a software asset that is associated with the enterprise, e.g. the scores are within a threshold amount of each other. Thereafter, a confidence score can be generated using the build version if it is determined that the build version potentially matches a software asset that is associated with the enterprise.

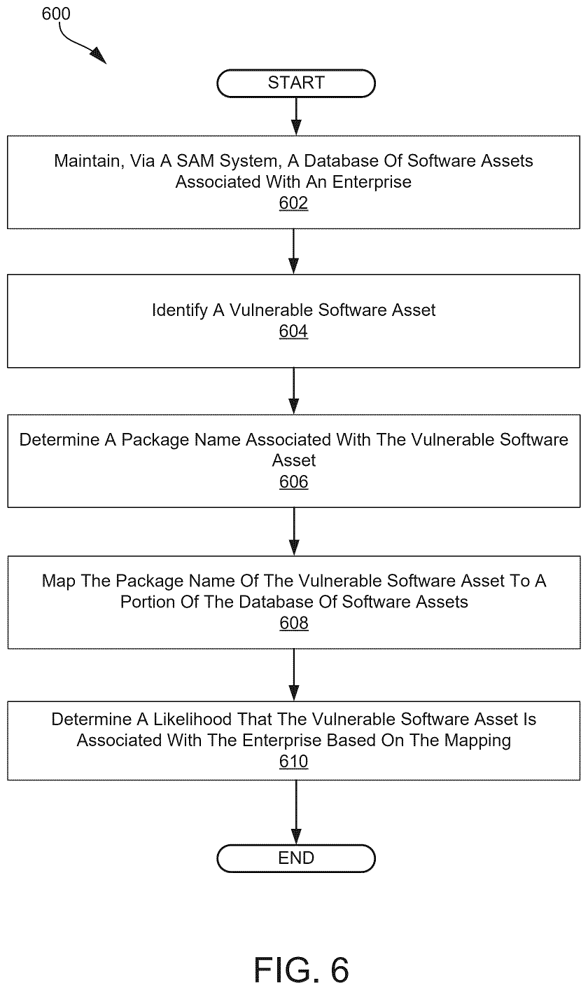

FIG. 6 illustrates a flowchart 600 of an example method of determining a likelihood that a vulnerable software asset is associated with an enterprise based on a package name associated with the vulnerable software asset, according to some examples of the present disclosure. The method shown in FIG. 6 is provided by way of example, as there are a variety of ways to carry out the method. Additionally, while the example method is illustrated with a particular order of steps, those of ordinary skill in the art will appreciate that FIG. 6 and the modules shown therein can be executed in any order and can include fewer or more modules than illustrated. Each module shown in FIG. 6 represents one or more steps, processes, methods or routines in the method. The modules will be discussed with respect to the example environments described herein.

At module 602, a database of software assets associated with an enterprise is maintained via a SAM system. Specifically, the SAM system 206 in the environment 200 shown in FIG. 2 can maintain the database of software assets associated with the enterprise. The database can be maintained in an agentless manner. The database of software assets associated with the enterprise can include models of packages associated with enterprise that are maintained by the SAM system 206.

At module 604, a vulnerable software asset is identified. The vulnerable software discovery system 202 can identify the vulnerable software asset. Specifically, the vulnerable software discovery system 202 can identify the vulnerable software based on manual input by a user, a database of standard-based vulnerability management data, solutions data published by a software developer, an SBOM associated with a software asset, or a combination thereof.

At module 606, a package name associated with the vulnerable software asset is determined. The vulnerable software discovery system 202 can identify the package name associated with the vulnerable software asset, e.g. as part of determining a descriptor for the vulnerable software asset. Specifically, the package name associated with the vulnerable software asset can be identified from an SBOM

At module 608, the package name of the vulnerable software asset is mapped to a potion of the database of software assets. Specifically, the vulnerable software asset mapping system 212 can map the package name, e.g. as included in a vulnerable software model stored in the vulnerable software model datastore 204, to a software package model stored in the software package model datastore 210. The software package model datastore 210 can store descriptors of software packages associated with the enterprise.

At module 610, a likelihood that the vulnerable software asset is associated with the enterprise is determined based on the mapping. Specifically, the vulnerable software asset mapping system 212 can determine a threat level for the vulnerable software asset in the enterprise based on the mapping of the package name of the vulnerable software asset to software packages associated with the enterprise. The vulnerable software asset mapping system 212 can determine the threat level in a similar manner to how the threat level is determined at module 410 in the flowchart 400 show in FIG. 4. The threat level of the vulnerable software asset can be quantified or qualified in an applicable way, e.g. a numerical confidence score indicating a likelihood that the vulnerable software asset is associated with the enterprise. The confidence score can be calculated by weighting the degree to which the package name of the vulnerable software asset matches a package name of a package associated with the enterprise.

As discussed previously, the software package models associated with the enterprise, can be maintained in an agentless manner. As follows, the mapping of the package name of the vulnerable software asset at module 608 and the subsequent threat assessment performed based on the mapping at module 610 can be performed in an agentless manner. Performing these modules in an agentless manner offers numerous technical advantages. Specifically, this can reduce time and computational resources used in ultimately performing a threat assessment for the enterprise. Further, this can obviate a need for any informational consistency between the enterprise and a third-party who provides the threat assessment.

The mapping of the software package name to the software packages associated with the enterprise at module 608 can be performed in conjunction with the mapping of other descriptors of the vulnerable software asset to software assets associated with the enterprise, e.g. as done at module 408 of the flowchart 400 shown in FIG. 4. In turn, the threat assessment of the vulnerable software asset performed at module 610 can be performed based on not only the mapping of the package name but also the mapping of other descriptors, such as the product name, the software developer, the version, the edition, and the build version. Performing modules 608 and 610 together with modules 408 and 410 in the flowchart 400 offers numerous technical advantages. Specifically, this can increase the diversity of descriptors that are mapped to software assets associated with the enterprise as well. Further, this can increase the diversity of metrics that are used in performing the threat assessment for the vulnerable software asset. As follows, this can lead to greater accuracy in the threat assessment for the vulnerable software asset.

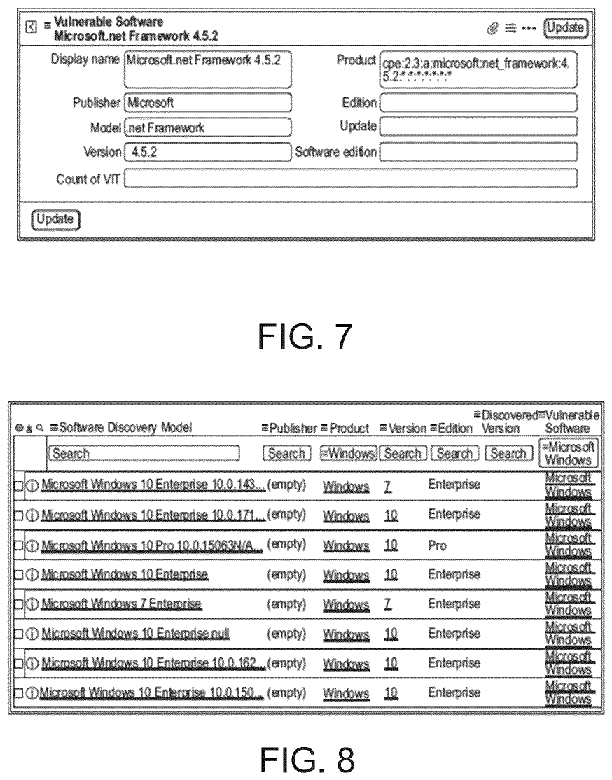

The disclosure now continues with a discussion of graphical user interfaces that illustrate how the technology can be implemented herein. FIG. 7 illustrates an example screenshot of an interface showing descriptors of a vulnerable software asset, according to some examples of the present disclosure. In the screenshot, the display name shows the presentation of the software asset in the CPE string. In this example the display name is “Microsoft.net Framework 4.5.2.” From the display name, the publisher “Microsoft”, the model “.net Framework”, and the version “4.5.2” are extracted. The interface also includes the identification of the product within the CPE string itself.

FIG. 8 illustrates an example screenshot of an interface showing a software model of an enterprise maintained by a SAM system, according to some examples of the present disclosure. The model includes numerous software assets in the same model. The model includes the display name, a publisher field, a product field, a version field, an edition field for each of the software assets.

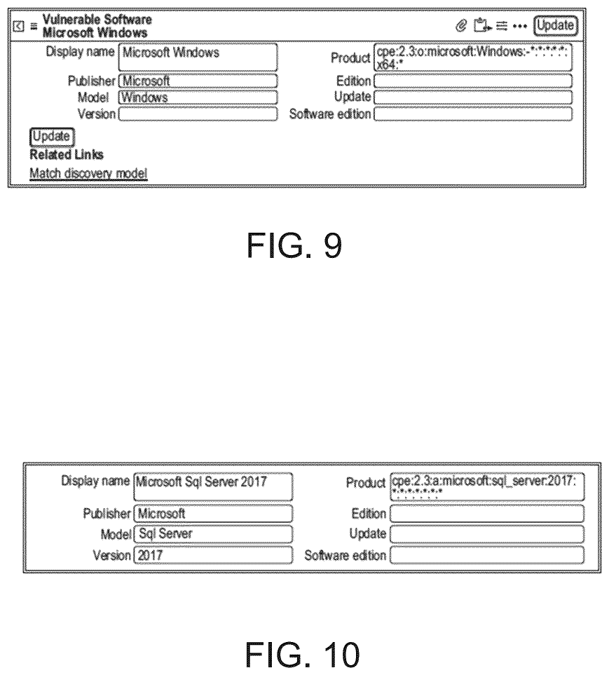

FIG. 9 illustrates an example screenshot of an interface showing descriptors of another vulnerable software asset, according to some examples of the present disclosure. This includes the display name, the publisher, the model, the version, and the product name for the vulnerable software asset.

FIG. 10 illustrates an example screenshot of an interface representing a mapping of descriptors of a vulnerable software asset to a portion of a database of software assets associated with an enterprise, according to some examples of the present disclosure. This mapping was used to perform a threat assessment with a confidence score of 0.60 that the vulnerable software asset is associated with the enterprise.

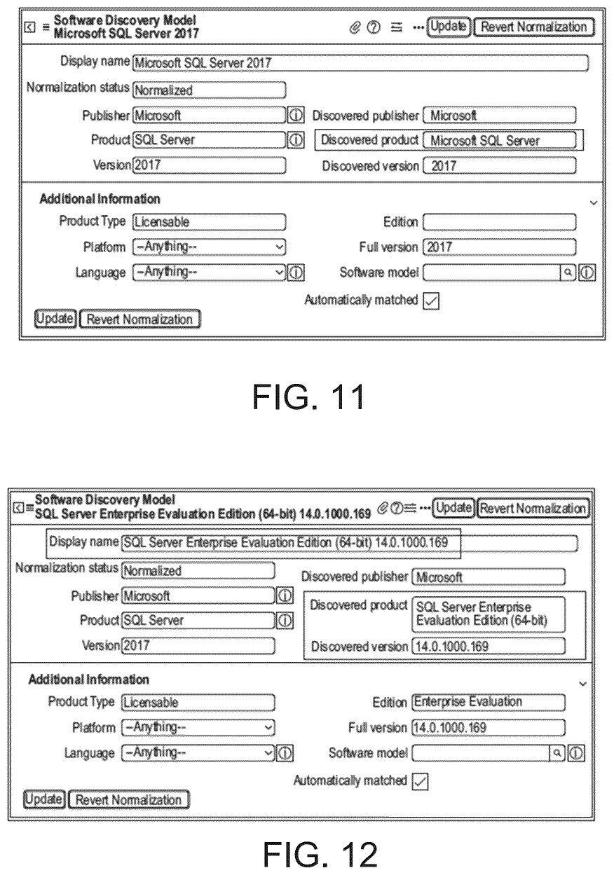

FIG. 11 illustrates an example screenshot of an interface representing a mapping of descriptors of a vulnerable software asset to a portion of a database of software assets associated with an enterprise, according to some examples of the present disclosure. This mapping was used to perform a threat assessment with a confidence score of 0.95 that the vulnerable software asset is associated with the enterprise.

FIG. 12 illustrates an example screenshot of an interface representing another mapping of descriptors of a vulnerable software asset to a portion of a database of software assets associated with an enterprise, according to some examples of the present disclosure. This mapping was used to perform a threat assessment with a confidence score of 0.85 that the vulnerable software asset is associated with the enterprise.

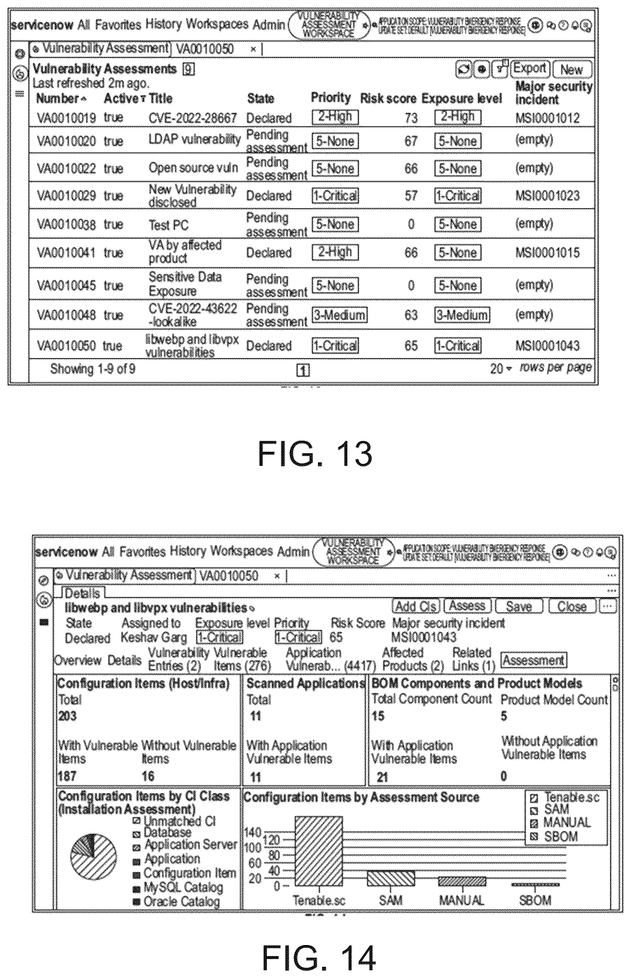

FIG. 13 illustrates an example screenshot of an interface showing an enterprise vulnerable software asset assessment and corresponding risk scores of vulnerable software assets, according to some examples of the present disclosure. Specifically, the threat assessment performed for different vulnerable software assets for the enterprise is represented, along with the risk scores and exposure level for each of the assets.

FIG. 14 illustrates an example screenshot of an interface showing a graphical representation of a vulnerability assessment, according to some examples of the present disclosure. The interface shows the threat assessments for various software assets in a graphical representation. Specifically, it shows how many vulnerable items and scanned application. It also shows a pie chart of where the vulnerable assets are located in the enterprise.

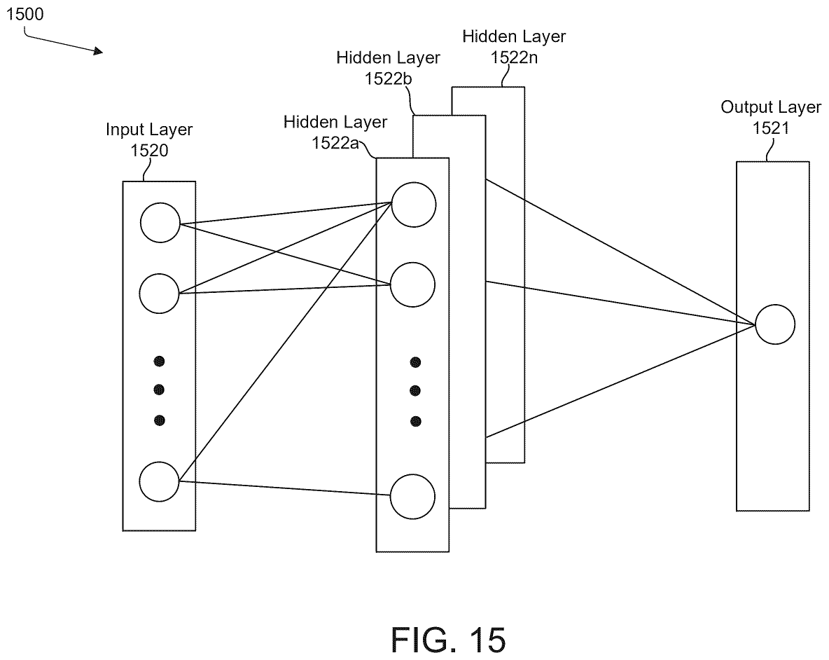

In FIG. 15, the disclosure now turns to a further discussion of models that can be used to implement the technology described herein. FIG. 15 is an example of a deep learning neural network 1500 that can be used to implement all or a portion of the systems and techniques described herein, according to some examples of the present disclosure. An input layer 1520 can be configured to receive sensor data and/or data relating to an environment surrounding an AV. Neural network 1500 includes multiple hidden layers 1522a, 1522b, through 1522n. The hidden layers 1522a, 1522b, through 1522n include “n” number of hidden layers, where “n” is an integer greater than or equal to one. The number of hidden layers can be made to include as many layers as needed for the given application. Neural network 1500 further includes an output layer 1521 that provides an output resulting from the processing performed by the hidden layers 1522a, 1522b, through 1522n.

Neural network 1500 is a multi-layer neural network of interconnected nodes. Each node can represent a piece of information. Information associated with the nodes is shared among the different layers and each layer retains information as information is processed. In some cases, the neural network 1500 can include a feed-forward network, in which case there are no feedback connections where outputs of the network are fed back into itself. In some cases, the neural network 1500 can include a recurrent neural network, which can have loops that allow information to be carried across nodes while reading in input.

Information can be exchanged between nodes through node-to-node interconnections between the various layers. Nodes of the input layer 1520 can activate a set of nodes in the first hidden layer 1522a. For example, as shown, each of the input nodes of the input layer 1520 is connected to each of the nodes of the first hidden layer 1522a. The nodes of the first hidden layer 1522a can transform the information of each input node by applying activation functions to the input node information. The information derived from the transformation can then be passed to and can activate the nodes of the next hidden layer 1522b, which can perform their own designated functions. Example functions include convolutional, up-sampling, data transformation, and/or any other suitable functions. The output of the hidden layer 1522b can then activate nodes of the next hidden layer, and so on. The output of the last hidden layer 1522n can activate one or more nodes of the output layer 1521, at which an output is provided. In some cases, while nodes in the neural network 1500 are shown as having multiple output lines, a node can have a single output and all lines shown as being output from a node represent the same output value.

In some cases, each node or interconnection between nodes can have a weight that is a set of parameters derived from the training of the neural network 1500. Once the neural network 1500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1500 to be adaptive to inputs and able to learn as more and more data is processed.

The neural network 1500 is pre-trained to process the features from the data in the input layer 1520 using the different hidden layers 1522a, 1522b, through 1522n in order to provide the output through the output layer 1521.

In some cases, the neural network 1500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 1500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 1500 can perform a backward pass by determining which inputs (weights) most contributed to the loss of the network, and can adjust the weights so that the loss decreases and is eventually minimized.

The neural network 1500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 1500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwisc Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

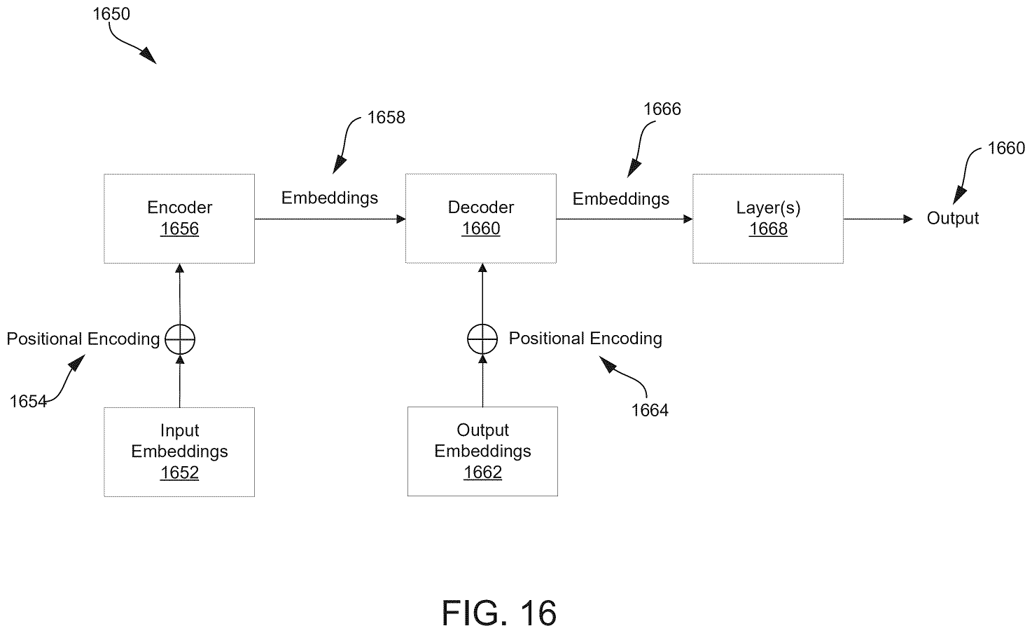

FIG. 16 is a diagram illustrating an example architecture of an example transformer model 1650, according to some examples of the present disclosure. The transformer model 1650 can be used to implement an LLM that can be used to implement the technology described herein. As shown, the transformer model 1650 can include input embeddings 1652 used as inputs to the transformer model 1650. The input embeddings 1652 can include input values representing words and/or sentences, such as numbers or vectors representing words and/or sentences.

In some cases, the input embeddings 1652 can function like a dictionary that helps the transformer model 1650 understand the meaning of words by placing them in an embedding space where similar words are located near each other. In some examples, the input interface 134 can be trained and/or configured to create the input embeddings 1652 so that similar vectors represent words with similar meanings. In some examples, the transformer model 1650 can additionally or alternatively learn to create and/or process the input embeddings 1652 during training.

The transformer model 1650 can use positional encoding 1654 to encode the position of each word in an input sequence from the input embeddings 1652 as values such as a set of numbers, a vector, etc. The values generated by the positional encoding 1654 can be fed into the transformer model 1650 along with the input embeddings 1652. By incorporating the positional encoding 1654 into the transformer model 1650, the transformer model 1650 can more effectively understand the order of words in a sentence and generate grammatically correct and semantically meaningful output.

The transformer model 1650 can include an encoder(s) 1656 used to process the positionally encoded input embeddings 1652 and generate embeddings 1658. The encoder(s) 1656 can be part of the transformer model 1650 that processes input text and generates hidden states that capture the meaning and context of the text. For example, the encoder(s) 1656 can include a feed-forward neural network that is part of the transformer model 1650. In some examples, the encoder(s) 1656 can implement multiple encoder layers. In some cases, the encoder(s) 1656 can first tokenize the input text into a sequence of tokens, such as individual words or subwords. The encoder(s) 1656 can then apply one or more self-attention layers, which can generate hidden states that represent the input text at different levels of abstraction. In this way, the encoder(s) 1656 can generate the embeddings 1658 (e.g., a vector, a set of values, etc.) representing the semantics and position of words in one or more sentences.

The transformer model 1650 can include output embeddings 1662, which can include values representing words and/or sentences, such as numbers or vectors representing words and/or sentences. The output embeddings 1662 can be similar to the input embeddings 1652 and can also be processed by positional encoding 1664 to encode the position of each word in a sequence from the output embeddings 1662 as values such as a set of numbers, a vector, etc., which helps the transformer model 1650 understand the order of words in a sentence. The output embeddings 1662 can be used during a training phase of the transformer model 1650 and can be used during an inference phase. During training, a loss function can be computed based on the output embeddings 1662 and used to update the model parameters to improve the accuracy of the transformer model 1650. During an inference phase, the output embeddings 1662 can be used to generate the output text by mapping the predicted probabilities determined by the transformer model 1650 for each token to the corresponding token in the vocabulary.

The positionally encoded input embeddings 1652 (e.g., the embeddings 1658) and the positionally encoded output embeddings 1662 can be fed to a decoder(s) 1660 used to generate the output sequence based on the encoded input sequence. During training, the decoder(s) 1660 can learn how to guess the next word of a sequence by looking at the words before it. In some examples, the decoder(s) 1660 can generate natural language text based on the input sequence and any learned context.

The decoder(s) 1660 can generate embeddings 1666 and feed the embeddings 1666 to one or more network layers 1668. In some examples, the one or more network layers 1668 can include a linear layer and a softmax function. The linear layer can map the embeddings 1666 generated by the decoder(s) 1660 to a higher-dimensional space, which can transform the embeddings 1666 into the original input space. The softmax function can then be applied to generate a probability distribution for each output token in the vocabulary, which can result in an output 1670. In some examples, the output 1670 can include output tokens with probabilities.

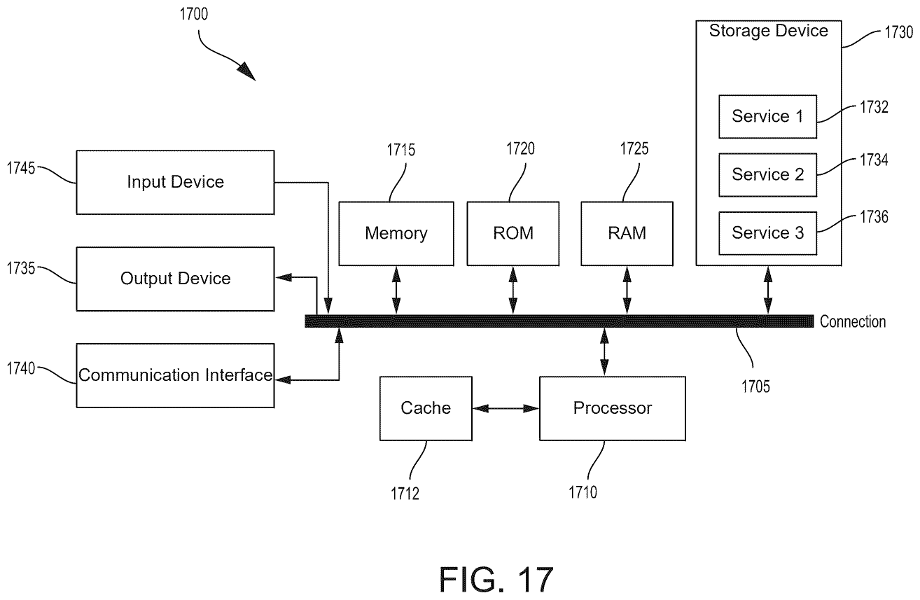

FIG. 17 illustrates an example processor-based system with which some aspects of the subject technology can be implemented. For example, processor-based system 1700 can be any computing device making up, or any component thereof in which the components of the system are in communication with each other using connection 1705. Connection 1705 can be a physical connection via a bus, or a direct connection into processor 1710, such as in a chipset architecture. Connection 1705 can also be a virtual connection, networked connection, or logical connection.

In some embodiments, computing system 1700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1700 includes at least one processing unit (Central Processing Unit (CPU) or processor) 1710 and connection 1705 that couples various system components including system memory 1715, such as Read-Only Memory (ROM) 1720 and Random-Access Memory (RAM) 1725 to processor 1710. Computing system 1700 can include a cache of high-speed memory 1712 connected directly with, in close proximity to, or integrated as part of processor 1710.

Processor 1710 can include any general-purpose processor and a hardware service or software service, such as services 1732, 1734, and 1736 stored in storage device 1730, configured to control processor 1710 as well as a special-purpose processor where software instructions are incorporated into the actual processor design. Processor 1710 may essentially be a completely self-contained computing system, containing multiple cores or processors, a bus, memory controller, cache, etc. A multi-core processor may be symmetric or asymmetric.

To enable user interaction, computing system 1700 includes an input device 1745, which can represent any number of input mechanisms, such as a microphone for speech, a touch-sensitive screen for gesture or graphical input, keyboard, mouse, motion input, speech, etc. Computing system 1700 can also include output device 1735, which can be one or more of a number of output mechanisms known to those of skill in the art. In some instances, multimodal systems can enable a user to provide multiple types of input/output to communicate with computing system 1700. Computing system 1700 can include communications interface 1740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 1740 may also include one or more Global Navigation Satellite System (GNSS) receivers or transceivers that are used to determine a location of the computing system 1700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 1730 can include software services, servers, services, etc., that when the code that defines such software is executed by the processor 1710, it causes the system 1700 to perform a function. In some embodiments, a hardware service that performs a particular function can include the software component stored in a computer-readable medium in connection with the necessary hardware components, such as processor 1710, connection 1705, output device 1735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:
Aspect 1. A computer-implemented method comprising: while maintaining, via a software asset management (SAM) system, a database of software assets associated with an enterprise: identifying a vulnerable software asset; obtaining a descriptor of the vulnerable software asset; mapping the descriptor of the vulnerable software asset to a portion of the database of software assets; and determining a likelihood that the vulnerable software asset is associated with the enterprise based on the mapping.
Aspect 2. The computer-implemented method of Aspect 1, further comprising identifying the portion of the database of software assets by determining that the portion of the database of software assets matches within a specific degree to the descriptor of the vulnerable software asset.
Aspect 3. The computer-implemented method of either Aspect 1 or 2, wherein the descriptor of the vulnerable software asset is mapped to the portion of the database of software assets through approximate string matching.
Aspect 4. The computer-implemented method of any of Aspects 1 through 3, wherein the database of software assets is maintained in an agentless manner without analyzing runtime software flows on devices associated with the enterprise.
Aspect 5. The computer-implemented method of any of Aspects 1 through 4, wherein the software asset is identified as the vulnerable software asset based on data accessed through a database of standards-based vulnerability management data, solutions data published by a software developer, vulnerability data manually input by a user, a software bill of materials (SBOM) associated with the software asset, or a combination thereof.
Aspect 6. The computer-implemented method of any of any of Aspects 1 through 5, wherein the descriptor of the vulnerable software asset is identified from a Common Vulnerabilities and Exposures (CVE) entry associated with the software asset, a Common Platform Enumeration (CPE) entry associated with the software asset, an SBOM associated with the software asset, or a combination thereof.
Aspect 7. The computer-implemented method of any of Aspects 1 through 6, further comprising: accessing an entry of the vulnerable software asset in a structured naming scheme; extracting an identification of a publisher and an identification of a product name of the vulnerable software asset from the entry as part of obtaining the descriptor of the vulnerable software asset; mapping the identification of the publisher and the identification of the product name of the vulnerable software asset to the portion of the database of software assets; and determining the likelihood that the vulnerable software asset is associated with the enterprise based on the mapping of the identification of the publisher and the identification of the product name of the vulnerable software asset to the portion of the database of software.
Aspect 8. The computer-implemented method of any of Aspects 1 through 7, further comprising: accessing an entry of the vulnerable software asset in a structured naming scheme; extracting an identification of a version and an identification of an edition of the vulnerable software asset from the entry as part of obtaining the descriptor of the vulnerable software asset; mapping the identification of the version and the identification of the edition of the vulnerable software asset to the portion of the database of software assets; and determining the likelihood that the vulnerable software asset is associated with the enterprise based on the mapping.
Aspect 9. The computer-implemented method of Aspect 8, further comprising: applying a machine learning model based on the identification of the version and the identification of the edition of the vulnerable software to determine a plurality of build versions of the vulnerable software asset; mapping the plurality of build versions of the vulnerable software asset to the portion of database of software assets; and determining the likelihood that the vulnerable software asset is associated with the enterprise based on the mapping.
Aspect 10. The computer-implemented method of any of Aspects 1 through 9, further comprising: determining an identification of a publisher of the vulnerable software asset, an identification of a product name of the vulnerable software asset, an identification of a version of the vulnerable software asset, an identification of an edition of the vulnerable software asset, a build version of the vulnerable software asset, or a combination thereof from an entry of the vulnerable software asset in a structured naming scheme as part of obtaining the descriptor of the vulnerable software asset; mapping the identification of the publisher of the vulnerable software asset, the identification of the product name of the vulnerable software asset, the identification of the version of the vulnerable software asset, the identification of the edition of the vulnerable software asset, the build version of the vulnerable software asset, or the combination thereof to the portion of the database of software assets; and determining a numerical score indicative of the likelihood that the vulnerable software asset is associated with the enterprise based on the mapping.
Aspect 11. The computer-implemented method of Aspect 10, further comprising determining the numerical score based on a degree to which the identification of the publisher of the vulnerable software asset, the identification of the product name of the vulnerable software asset, the identification of the version of the vulnerable software asset, the identification of the edition of the vulnerable software asset, the build version of the vulnerable software asset, or the combination thereof matches an entry in the database of software assets present in the enterprise.
Aspect 12. The computer-implemented method of any of Aspects 1 through 11, further comprising: determining an identification of a software package associated with the vulnerable software asset as part of obtaining the descriptor of the vulnerable software asset; mapping the identification of the software package associated with the vulnerable software asset to the portion of the database of software assets; and determining the likelihood that the vulnerable software asset is associated with the enterprise based on the mapping.
Aspect 13. A system comprising: one or more processors; and at least one computer-readable storage medium having stored therein instructions which, when executed by the one or more processors, cause the one or more processors to, while maintaining, via a software asset management (SAM) system, a database of software assets associated with an enterprise: identify a vulnerable software asset; obtain a descriptor of the vulnerable software asset; map the descriptor of the vulnerable software asset to a portion of the database of software assets; and determine a likelihood that the vulnerable software asset is associated with the enterprise based on the mapping.
Aspect 14. The system of Aspect 13, wherein the instructions are further configured to cause the one or more processors to identify the portion of the database of software assets by determining that the portion of the database of software assets matches within a specific degree to the descriptor of the vulnerable software asset.
Aspect 15. The system of either Aspects 13 or 14, wherein the instructions are further configured to cause the one or more processors to map the descriptor of the vulnerable software asset to the portion of the database of software assets through approximate string matching.
Aspect 16. The system of any of Aspects 13 through 15, wherein the database of software assets is maintained in an agentless manner without analyzing runtime software flows on devices associated with the enterprise.
Aspect 17. The system of any of Aspects 13 through 16, wherein the software asset is identified as the vulnerable software asset based on data accessed through a database of standards-based vulnerability management data, solutions data published by a software developer, vulnerability data manually input by a user, a software bill of materials (SBOM) associated with the software asset, or a combination thereof.
Aspect 18. The system of any of Aspects 13 through 17, wherein the descriptor of the vulnerable software asset is identified from a Common Vulnerabilities and Exposures (CVE) entry associated with the software asset, a Common Platform Enumeration (CPE) entry associated with the software asset, an SBOM associated with the software asset, or a combination thereof.
Aspect 19. A non-transitory computer-readable storage medium storing instructions for causing one or more processors to, while maintaining, via a software asset management (SAM) system, a database of software assets associated with an enterprise: identify a vulnerable software asset; obtain a descriptor of the vulnerable software asset; map the descriptor of the vulnerable software asset to a portion of the database of software assets; and determine a likelihood that the vulnerable software asset is associated with the enterprise based on the mapping.
Aspect 20. The non-transitory computer-readable storage medium of Aspect 19, wherein the instructions are further configured to cause the one or more processors to identify the portion of the database of software assets by determining that the portion of the database of software assets matches within a specific degree to the descriptor of the vulnerable software asset.
Aspect 21. A system comprising means for performing a method according to any of Aspects 1 through 12.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
while maintaining, via a software asset management (SAM) system, a database of software assets associated with an enterprise:
identifying a vulnerable software asset;
obtaining a descriptor of the vulnerable software asset;
mapping the descriptor of the vulnerable software asset to a portion of the database of software assets; and
determining a likelihood that the vulnerable software asset is associated with the enterprise based on the mapping.

2. The computer-implemented method of claim 1, further comprising identifying the portion of the database of software assets by determining that the portion of the database of software assets matches within a specific degree to the descriptor of the vulnerable software asset.

3. The computer-implemented method of claim 1, wherein the descriptor of the vulnerable software asset is mapped to the portion of the database of software assets through approximate string matching.

4. The computer-implemented method of claim 1, wherein the database of software assets is maintained in an agentless manner without analyzing runtime software flows on devices associated with the enterprise.

5. The computer-implemented method of claim 1, wherein the software asset is identified as the vulnerable software asset based on data accessed through a database of standards-based vulnerability management data, solutions data published by a software developer, vulnerability data manually input by a user, a software bill of materials (SBOM) associated with the software asset, or a combination thereof.

6. The computer-implemented method of claim 1, wherein the descriptor of the vulnerable software asset is identified from a Common Vulnerabilities and Exposures (CVE) entry associated with the software asset, a Common Platform Enumeration (CPE) entry associated with the software asset, an SBOM associated with the software asset, or a combination thereof.

7. The computer-implemented method of claim 1, further comprising:
accessing an entry of the vulnerable software asset in a structured naming scheme;
extracting an identification of a publisher and an identification of a product name of the vulnerable software asset from the entry as part of determining the descriptor of the vulnerable software asset;
mapping the identification of the publisher and the identification of the product name of the vulnerable software asset to the portion of the database of software assets; and
determining the likelihood that the vulnerable software asset is associated with the enterprise based on the mapping of the identification of the publisher and the identification of the product name of the vulnerable software asset to the portion of the database of software.

8. The computer-implemented method of claim 1, further comprising:
accessing an entry of the vulnerable software asset in a structured naming scheme;
extracting an identification of a version and an identification of an edition of the vulnerable software asset from the entry as part of obtaining the descriptor of the vulnerable software asset;
mapping the identification of the version and the identification of the edition of the vulnerable software asset to the portion of the database of software assets; and
determining the likelihood that the vulnerable software asset is associated with the enterprise based on the mapping.

9. The computer-implemented method of claim 8, further comprising:
applying a machine learning model based on the identification of the version and the identification of the edition of the vulnerable software to determine a plurality of build versions of the vulnerable software asset;
mapping the plurality of build versions of the vulnerable software asset to the portion of database of software assets; and
determining the likelihood that the vulnerable software asset is associated with the enterprise based on the mapping.

10. The computer-implemented method of claim 1, further comprising:
determining an identification of a publisher of the vulnerable software asset, an identification of a product name of the vulnerable software asset, an identification of a version of the vulnerable software asset, an identification of an edition of the vulnerable software asset, a build version of the vulnerable software asset, or a combination thereof from an entry of the vulnerable software asset in a structured naming scheme as part of obtaining the descriptor of the vulnerable software asset;
mapping the identification of the publisher of the vulnerable software asset, the identification of the product name of the vulnerable software asset, the identification of the version of the vulnerable software asset, the identification of the edition of the vulnerable software asset, the build version of the vulnerable software asset, or the combination thereof to the portion of the database of software assets; and
determining a numerical score indicative of the likelihood that the vulnerable software asset is associated with the enterprise based on the mapping.

11. The computer-implemented method of claim 10, further comprising determining the numerical score based on a degree to which the identification of the publisher of the vulnerable software asset, the identification of the product name of the vulnerable software asset, the identification of the version of the vulnerable software asset, the identification of the edition of the vulnerable software asset, the build version of the vulnerable software asset, or the combination thereof matches an entry in the database of software assets present in the enterprise.

12. The computer-implemented method of claim 1, further comprising:
determining an identification of a software package associated with the vulnerable software asset as part of obtaining the descriptor of the vulnerable software asset;
mapping the identification of the software package associated with the vulnerable software asset to the portion of the database of software assets; and
determining the likelihood that the vulnerable software asset is associated with the enterprise based on the mapping.

13. A system comprising:
one or more processors; and
at least one computer-readable storage medium having stored therein instructions which, when executed by the one or more processors, cause the one or more processors to, while maintaining, via a software asset management (SAM) system, a database of software assets associated with an enterprise:
identify a vulnerable software asset;
obtain a descriptor of the vulnerable software asset;
map the descriptor of the vulnerable software asset to a portion of the database of software assets; and
determine a likelihood that the vulnerable software asset is associated with the enterprise based on the mapping.

14. The system of claim 13, wherein the instructions are further configured to cause the one or more processors to identify the portion of the database of software assets by determining that the portion of the database of software assets matches within a specific degree to the descriptor of the vulnerable software asset.

15. The system of claim 13, wherein the instructions are further configured to cause the one or more processors to map the descriptor of the vulnerable software asset to the portion of the database of software assets through approximate string matching.

16. The system of claim 13, wherein the database of software assets is maintained in an agentless manner without analyzing runtime software flows on devices associated with the enterprise.

17. The system of claim 13, wherein the software asset is identified as the vulnerable software asset based on data accessed through a database of standards-based vulnerability management data, solutions data published by a software developer, vulnerability data manually input by a user, a software bill of materials (SBOM) associated with the software asset, or a combination thereof.

18. The system of claim 13, wherein the descriptor of the vulnerable software asset is identified from a Common Vulnerabilities and Exposures (CVE) entry associated with the software asset, a Common Platform Enumeration (CPE) entry associated with the software asset, an SBOM associated with the software asset, or a combination thereof.

19. A non-transitory computer-readable storage medium storing instructions for causing one or more processors to, while maintaining, via a software asset management (SAM) system, a database of software assets associated with an enterprise:
identify a vulnerable software asset;
obtain a descriptor of the vulnerable software asset;
map the descriptor of the vulnerable software asset to a portion of the database of software assets; and
determine a likelihood that the vulnerable software asset is associated with the enterprise based on the mapping.

20. The non-transitory computer-readable storage medium of claim 19, wherein the instructions are further configured to cause the one or more processors to identify the portion of the database of software assets by determining that the portion of the database of software assets matches within a specific degree to the descriptor of the vulnerable software asset.
